(19) United States
(12) Patent Application Publication
(10) Pub. No.: US 2019/0362159 A1
(43) Pub. Date: Nov. 28, 2019

(54) CROWD SOURCED CONSTRUCTION ZONE DETECTION FOR AUTONOMOUS VEHICLE MAP MAINTENANCE

(71) Applicant: GM GLOBAL TECHNOLOGY OPERATIONS LLC, Detroit, MI (US)

(72) Inventor: Robert B. Cooley, Ann Arbor, MI (US)

(73) Assignee: GM GLOBAL TECHNOLOGY OPERATIONS LLC, Detroit, MI (US)

(21) Appl. No.: 15/987,094

(22) Filed: May 23, 2018

(51) Int. Cl. G06K 9/00; H04N 7/18

(52) U.S. Cl. CPC G06K 9/00791; G05D 1/0088; H04N 7/18

(57) ABSTRACT

A method for construction zone detection is provided. The method includes automatically capturing, via an onboard optical sensor on a vehicle, a plurality of images of a road along a path traveled by the vehicle; transmitting captured images to an off-board datacenter; identifying, by a processor in the vehicle, images that provide evidence of the existence of a construction zone on the road; transmitting, to the datacenter, location data identifying the location of the construction zone; and transmitting, to the datacenter, data identifying the frames of image data that provide evidence of the existence of the construction zone. A mapper can review the location data and the image data to confirm the existence of a construction zone and cause the location of the construction zone to be added to a listing of active construction zones, wherein the listing can be provided to autonomous vehicles.

### BACKGROUND

The present disclosure generally relates to systems and methods for detecting construction zones, and more particularly relates to systems and methods for detecting construction zones using crowd sourcing.

Autonomous vehicles (AVs) may not be able to navigate optimally when construction zones are encountered. As a result, AVs may attempt to generate routes that avoid construction zones. Construction zones may not be well documented. Municipalities and utility providers may be relied on to provide information regarding construction zone locations. Municipalities and utility providers, however, may not provide updated information regarding construction zone locations accurately and/or in a timely manner. When a new construction zone is encountered, an AV may not have sufficient information to adjust its travel pathway to avoid the construction zone and may become disabled as a result.

Accordingly, it is desirable to provide systems and methods for detecting construction zones more accurately and in a timelier manner. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for crowd sourced construction zone detection. In one embodiment, a processor-implemented method for construction zone detection is provided. The method includes automatically capturing, via an onboard optical sensor on a vehicle, a plurality of images of a road along a path traveled by the vehicle; transmitting at least a portion of the captured images to an off-board datacenter; identifying, by a processor in the vehicle, images that provide evidence of the existence of a construction zone on the road at a first construction zone location; transmitting, to the datacenter, location data identifying the first construction zone location; and transmitting, to the datacenter, image frame identification data identifying frames of image data that provide evidence of the existence of the construction zone at the first construction zone location. The location data and images corresponding to the image frame identification data are reviewed off-board the vehicle to confirm the existence of the construction zone at the first construction zone location and the first construction zone location is added to a listing of active construction zones when the existence of the construction zone at the first construction zone location is confirmed.

In one embodiment, the location data and images corresponding to the image frame identification data are reviewed by an off-board processing module configured by programming instructions to confirm the existence of a construction zone through reviewing the transmitted images.

In one embodiment, the location data and images corresponding to the image frame identification data are reviewed by a person trained to confirm the existence of a construction zone through reviewing the transmitted images.

In one embodiment, the method further includes receiving a copy of the listing of active construction zones.

In one embodiment, transmitting at least a portion of the captured images to an off-board datacenter includes transmitting to the datacenter the frames of image data that provide evidence that the construction zone exists at the first construction zone location, wherein the first construction zone location is not included in the listing of active construction zones.

In one embodiment, the method further includes reviewing images corresponding to a second construction zone location identified in the listing of active construction zones and confirming that a construction zone exists at the second construction zone location.

In one embodiment, transmitting at least a portion of the captured images to an off-board datacenter includes transmitting to the datacenter frames of image data that provide evidence that a construction zone exists at the second construction zone location.

In one embodiment, the method further includes reviewing images corresponding to a third construction zone location identified in the listing of active construction zones; determining that a construction zone does not exist at the third construction zone location; and transmitting, to the datacenter, construction zone identification data indicating that a construction zone does not exist at the third construction zone location and identifying the frames of image data that provide evidence that a construction zone does not exist at the third construction zone location.

In one embodiment, transmitting at least a portion of the captured images to an off-board datacenter includes transmitting to the datacenter the frames of image data that provide evidence that the third construction zone does not exist.

In one embodiment, the captured images include a dashcam video captured from a dedicated dashcam device or images captured from a smartphone in the vehicle.

In one embodiment, the captured images include images captured by a perception sensor integrated within the vehicle.

In another embodiment, a construction zone detection module in a vehicle is provided. The construction zone detection module includes one or more processors configured by programming instructions in non-transient computer readable media. The construction zone detection module is configured to: capture, via an onboard optical sensor on a vehicle, a plurality of images of a road along a path traveled by the vehicle; transmit at least a portion of the captured images to an off-board datacenter; identify images that provide evidence of the existence of a construction zone on the road at a first construction zone location; transmit, to the datacenter, location data identifying the first construction zone location; and transmit, to the datacenter, image frame identification data identifying frames of image data that provide evidence of the existence of the construction zone at the first construction zone location. The location data and images corresponding to the image frame identification data are reviewed off-board the vehicle to confirm the existence of the construction zone at the first construction zone location and the first construction zone location is added to a listing of active construction zones when the existence of the construction zone at the first construction zone location is confirmed.

In one embodiment, the construction zone detection module is further configured to save a copy of the listing of active construction zones received from the datacenter, review images corresponding to a second construction zone location identified in the listing of active construction zones, and confirm that a construction zone exists at the second construction zone location identified in the listing of active construction zones.

In one embodiment, the construction zone detection module is configured to transmit to the datacenter the frames of image data that provide evidence that the construction zone exists at the second construction zone location.

In one embodiment, the construction zone detection module is further configured to save a copy of the listing of active construction zones received from the datacenter, review images corresponding to a third construction zone location identified in the listing of active construction zones; determine that a construction zone does not exists at the third construction zone location; and transmit, to the datacenter, third construction zone identification data indicating that a construction zone does not exist at the third construction zone location.

In one embodiment, the construction zone detection module is configured to transmit to the datacenter frames of image data that provide evidence that a construction zone does not exist at the third construction zone location, and wherein the third construction zone identification data identifies the frames of image data that provide evidence that a construction zone does not exist at the third construction zone location.

In another embodiment, a processor-implemented method for construction zone detection is provided. The method includes: receiving, by a processor from a plurality of vehicles, images of a road traveled by the vehicles; receiving, by the processor from one or more of the plurality of vehicles, first construction zone data identifying a potential construction zone location; reviewing the first construction zone data and images corresponding to the first construction zone data to confirm the existence of a construction zone at the potential construction zone location; adding the potential construction zone location to a listing of active construction zones when the existence of a construction zone at the potential construction zone location is confirmed; and transmitting the listing of active construction zones to an autonomous vehicle (AV) for use by the AV in identifying areas to avoid.

In one embodiment, the method further includes transmitting the listing of active construction zones to the plurality of vehicles; receiving, from one or more of the plurality of vehicles, second construction zone data indicating that a former construction zone location included in the listing of active construction zones is no longer an active construction zone; reviewing the second construction zone data and images corresponding to the second construction zone data to confirm that the former construction zone location is no longer an active construction zone; and removing the former construction zone location from the listing of active construction zones when it is confirmed that the former construction zone location is no longer an active construction zone.

In one embodiment, reviewing the first construction zone data and images and reviewing the second construction zone data and images are performed by a human mapper trained to review and confirm construction zone data and images.

In one embodiment, reviewing the first construction zone data and images and reviewing the second construction zone data and images are performed by a processing module configured by programming instructions to review and confirm construction zone data and images.

In another embodiment, a processor-implemented method for construction zone detection is provided. The method includes: receiving, by a processor from a plurality of vehicles, images from one or more roads traveled by the vehicles; reviewing the received images to identify specific images that provide evidence of the existence of a construction zone at a first construction zone location on the road or provide evidence that a construction zone no longer exists at a second construction zone location that had been previously identified as a construction zone location; adding the first construction zone location to a listing of active construction zones when the existence of a construction zone at the first construction zone location is identified; removing the second construction zone location from the listing of active construction zones when it is determined that a construction zone no longer exists at the second construction zone location; and transmitting the listing of active construction zones to an autonomous vehicle (AV) for use by the AV in identifying areas to avoid.

### DESCRIPTION OF THE DRAWINGS

The exemplary embodiments will hereinafter be described in conjunction with the following drawing figures, wherein like numerals denote like elements, and wherein:

FIG. 1 is a block diagram depicting an example crowd sourced construction zone detection system, in accordance with various embodiments;

FIG. 2 is a block diagram of an example vehicle that may employ a construction zone detection module, in accordance with various embodiments;

FIG. 3 is a diagram depicting example operating scenarios in an example crowd sourced construction zone detection system, in accordance with various embodiments;

FIG. 4 is a block diagram depicting an example crowd sourced construction zone detection system, in accordance with various embodiments;

FIG. 5 is a process flow chart depicting an example process in a vehicle for crowd sourced detection of construction zones, in accordance with various embodiments; and

FIG. 6 is a process flow chart depicting an example process in a server for crowd sourced detection of construction zones, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Apparatus, systems, methods, techniques and articles are described for updating a listing of areas for an autonomous vehicle (AV) to avoid, such as construction zone areas. The updating may be performed using vision based construction zone detection modules that can be distributed on human driven ride share or personal vehicles, for example, by embedding the modules within a dashcam or a smart phone dashcam as a service application.

Apparatus, systems, methods, techniques and articles are described for distributing construction zone detection modules outside of an AV. The described apparatus, systems, methods, techniques and articles may accommodate the desire of some AV providers to have their AVs avoid construction zones during the initial launch of AVs. The described apparatus, systems, methods, techniques and articles may allow a listing of areas for the AV to avoid to be maintained more accurately, in a timelier manner, and with reduced cost. The described apparatus, systems, methods, techniques and articles may allow an AV provider to decrease mission failures in construction zones and increase availability in recently completed construction zones.

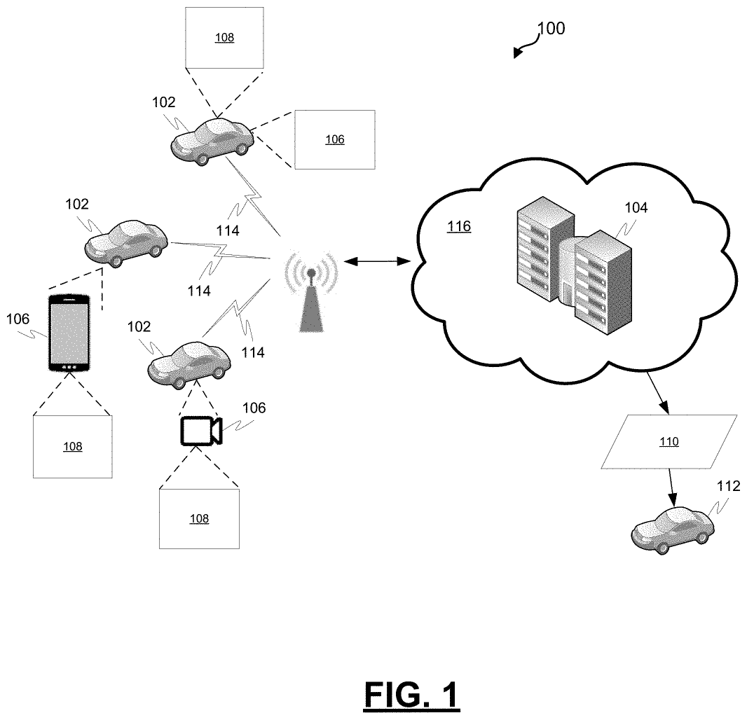

FIG. 1 is a block diagram depicting an example crowd sourced construction zone detection system 100. The example system 100 may, in real-time or near real-time, identify and create a listing of construction zones that can be shared with an autonomous vehicle to allow the autonomous vehicles to identify lanes in identified construction zones as being unavailable for travel.

The example crowd sourced construction zone detection system 100 includes a plurality of vehicles 102 and a cloud-based server that includes a datacenter 104. Each vehicle 102 includes a perception device 106 and a construction zone detection module 108. The perception device 106 may be selected from any number of devices, such as a dedicated dashcam device, a smartphone (e.g., attached to a windshield), onboard perception sensors (e.g., camera, lidar, radar, etc.), that is capable of recording images (or video) of a road traversed by the vehicle. The construction zone detection module 108 is configured to review images (or video) captured by the perception device and determine from the images whether evidence of a construction zone (e.g., a lane blockage or drivable surface impairment) exists at the image location. The construction zone detection module 108 may be incorporated in the perception device 106 (e.g., as part of a dedicated dashcam device or smartphone). The construction zone detection module 108 may be separate from the perception device 106, for example, when the perception device comprises onboard perception sensors. Evidence of a construction zone may include cones, signs, construction workers, etc. The construction zone detection module 108 is further configured to transmit the images captured by the perception devices 106 and construction zone indication data to the example datacenter 104.

The example datacenter 104 is configured to receive and store images received from the perception devices 106 associated with the vehicles 102, receive and store construction zone indication data from the vehicles 102, and compile and store a listing of lanes that have been identified as being unavailable for travel. A list 110 of areas to avoid can be derived from the listing of lanes that have been identified as being unavailable for travel and provided to autonomously driven vehicles 112. The construction zone detection modules 108 may communicate with the datacenter 104, for example, via a cellular communication channel 114 over a cellular network such as 4G LTE or 4G LTE-V2X, a public network, and a private network 116.

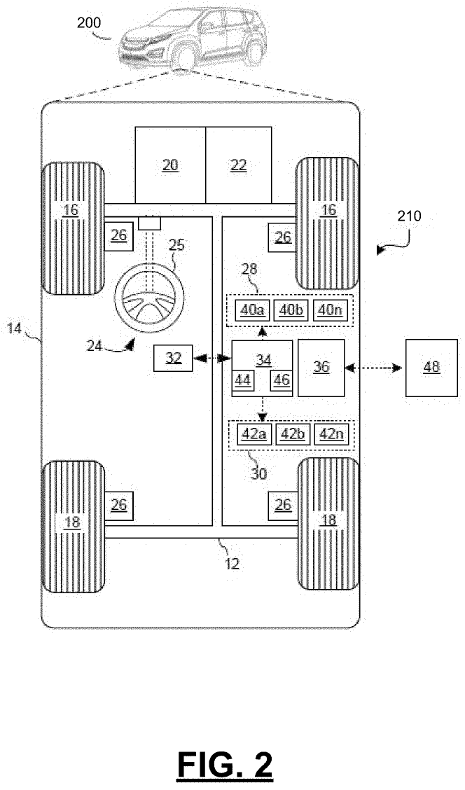

FIG. 2 is a block diagram of an example vehicle 200 that may employ a construction zone detection module 108. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14.

The example vehicle 200 may be an autonomous vehicle (e.g., a vehicle that is automatically controlled to carry passengers from one location to another), a semi-autonomous vehicle or a passenger-driven vehicle. In any case, a construction zone detection module 210 is incorporated into the example vehicle 200. The example vehicle 200 is depicted as a passenger car but may also be another vehicle type such as a motorcycle, truck, sport utility vehicle (SUV), recreational vehicles (RV), marine vessel, aircraft, etc.

The example vehicle 200 includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios.

The sensor system 28 includes one or more sensing devices 40a-40n that sense observable conditions of the exterior environment and/or the interior environment of the vehicle 200 (such as the state of one or more occupants) and generate sensor data relating thereto. Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, vehicle 200 may also include interior and/or exterior vehicle features not illustrated in FIG. 2, such as various doors, a trunk, and cabin features such as air, music, lighting, touch-screen display components (such as those used in connection with navigation systems), and the like.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 200. In various embodiments, controller 34 is configured to implement a construction zone detection module 210 as discussed in detail below.

The controller 34 may implement a construction zone detection module 210. That is, suitable software and/or hardware components of controller 34 (e.g., processor 44 and computer-readable storage device 46) are utilized to provide a construction zone detection module 210 that is used in conjunction with vehicle 200.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for controlling the components of the vehicle 200, and generate control signals that are transmitted to the actuator system 30 to automatically control the components of the vehicle 200 based on the logic, calculations, methods, and/or algorithms. Although only one controller 34 is shown in FIG. 2, embodiments of the vehicle 200 may include any number of controllers 34 that communicate over a suitable communication medium or a combination of communication mediums and that cooperate to process the sensor signals, perform logic, calculations, methods, and/or algorithms, and generate control signals to automatically control features of the vehicle 200.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

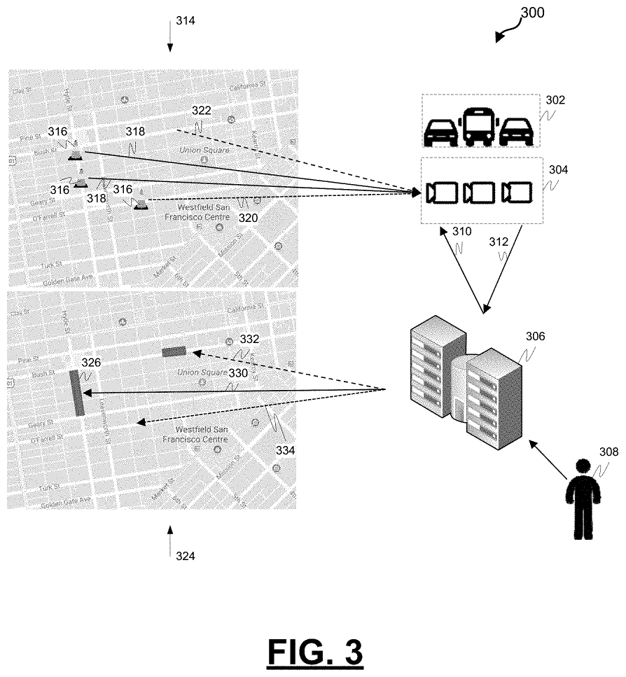

FIG. 3 is a diagram depicting example operating scenarios in an example crowd sourced construction zone detection system 300. The example crowd sourced construction zone detection system 300 includes a plurality of example vehicles 302, wherein each example vehicle 302 includes an example construction zone detection device 304 and each example construction zone detection device 304 includes a perception device (e.g., perception device 106) and a construction zone detection module (e.g., construction zone detection module 108). The example crowd sourced construction zone detection system 300 further includes an example datacenter 306 and a mapper 308.

The example construction zone detection devices 304 are configured to receive a listing 310 of previously identified construction zone locations from the datacenter 306 and provide, to the datacenter, data 312 identifying a construction zone location not included in the listing of previously identified construction zone locations or confirming the existence or non-existence of construction zones at the previously identified construction zone locations. As the vehicles 302 traverse an area, such as the area depicted in an example map 314, the construction zone detection devices 304 identify evidence of the existence or non-existence of construction zones that block lanes on roadways. The evidence may include, for example, cones 316, other barriers, detour signs, construction zone signs, the presence of construction workers, or other types of evidence. The construction zone detection devices 304 may identify evidence 318 that confirms the existence of a construction zone at a previously identified construction zone location. The construction zone detection devices 304 may identify evidence 320 of a newly identified construction zone at a location that had not been previously identified as a construction zone location. The construction zone detection devices 304 may identify evidence 322 that a construction zone does not exist at a previously identified construction zone location.

The data 312 identifying a construction zone location not included in the listing of previously identified construction zone locations or confirming the existence or non-existence of construction zones at the previously identified construction zone locations may include images, such as dashcam video (or still images), from a dedicated dashcam device, smartphone, tablet, phablet, or sensor (e.g., camera) integrated within the vehicle. The data 312 may also include the location of the previously identified construction zone or newly identified construction zone, information identifying the frames of video or still images that show the existence or non-existence of a construction zone at the site of the previously identified construction zone or newly identified construction zone, and an indicator that indicates whether a construction zone has been determined to exist or not exist at the location of the previously identified construction zone or newly identified construction zone.

The datacenter 306 is configured to receive the data 312, establish and/or update a database of known construction zones based on the received data 312, and provide, to the vehicles via the construction zone detection devices 304, a listing 310 of previously identified construction zone locations derived from the database of known construction zones. The continued existence of previously identified construction zone locations can be confirmed based on the received data 312 and retained in the database of known construction zones. The existence of newly identified construction zone locations can be confirmed based on the received data 312 and added to the database of known construction zones. The non-existence of a previously identified construction zone locations can be confirmed based on the received data 312 and those previously identified construction zone locations can be removed from the database of known construction zones.

As an alternative, the datacenter 306 may be configured to detect new construction zones, confirm the existence of previously identified construction zones, or detect that a formerly identified construction zone is no longer an active construction zone instead of the construction zone detection devices 304. Detection could be offloaded to the datacenter 306 to alleviate processing issues on the construction zone detection devices 304 or to secure the detection algorithm used in the detection module. In this alternative embodiment, datacenter 306 may be configured to receive from a plurality of vehicles, images from one or more roads traveled by the vehicles; review the received images to identify specific images that provide evidence of the existence of a construction zone at a first construction zone location on the road or provide evidence that a construction zone no longer exists at a second construction zone location that had been previously identified as a construction zone location; add the first construction zone location to a listing of active construction zones when the existence of a construction zone at the first construction zone location is identified; remove the second construction zone location from the listing of active construction zones when it is determined that a construction zone no longer exists at the second construction zone location; and transmit the listing of active construction zones to an autonomous vehicle (AV) for use by the AV in identifying areas to avoid.

A mapper 308 is provided to review and either confirm or reject the determinations of the construction zone detection devices 304 regarding the existence of construction zones. The mapper is configured to review the determinations made by the construction zone detection devices 304 regarding the existence of construction zones and the associated images (e.g., video and/or still images) and determine whether to keep previously identified construction zone locations in the database, add newly identified construction zone locations to the database, or remove previously identified construction zone locations from the database. The mapper may be a human mapper. Additionally, or alternatively, the mapper may be a computer implemented mapper.

An example AV map 324 that has been annotated with the listing of previously identified construction zone locations illustrates how an AV that receives the listing can use the information for navigation. An AV may receive the listing of previously identified construction zone locations or a version of the example AV map 324 from the datacenter 306. The example AV map 324 illustrates (via line 330) that a first previously identified construction zone location 326 is maintained and travel through that area should be avoided. The example AV map 324 illustrates (via line 332) that a second previously identified construction zone location 328 should be removed and travel through that area can resume. The example AV map 324 illustrates (via line 334) that a newly identified construction zone location should be added and travel through that area should be avoided.

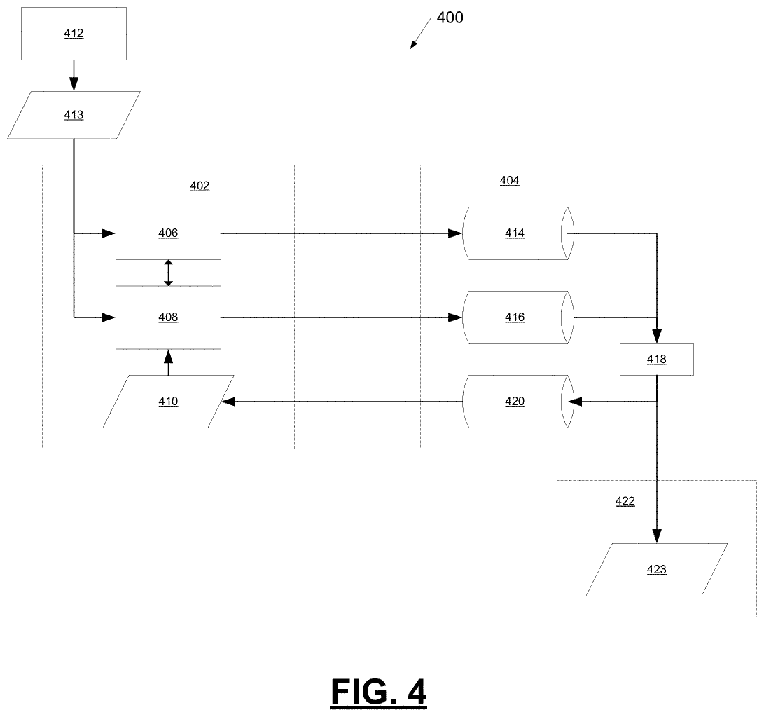

FIG. 4 is a block diagram depicting an example crowd sourced construction zone detection system 400. The example system includes a construction zone detection module 402 in one or more vehicles and a server 404.

The example construction zone detection module 402 includes one or more processors configured by programming instructions in non-transient computer readable media. The example construction zone detection module 402 includes a perception module 406 and a construction determination module 408. The example construction zone detection module 402 is configured to transmit images/video of a traversed roadway and data confirming the existence or non-existence of construction zones to the server 404 and configured to receive and store a copy of a listing 410 of areas to avoid from the server 404.

The example perception module 406 is configured to capture, via one or more perception sensors 412 (e.g., dashcam, camera on smartphone, or other perception sensor) on the vehicle, a plurality of images/video 413 of a road along a path traveled by the vehicle. The images may include video and/or still images. The images may correspond to a construction zone location identified in the listing 410, a newly identified construction zone location not identified in the listing 410, or other locations.

The example construction determination module 408 is configured to identify images that provide evidence of the existence of a construction zone on the road. The example construction determination module 408 is also configured identify images that provide evidence that a construction zone no longer exists at a previously identified construction zone location. The example construction determination module 408 is configured to transmit, to the server 404, location data identifying the location of an identified construction zone and data indicating that a construction zone no longer exists at a previously identified construction zone location. The example construction determination module 408 is further configured to transmit, to the server 404, image frame identification data identifying the frames of image data that provide evidence of the existence or non-existence of construction zones.

The example server 404 is configured to receive, from a plurality of vehicles, images of one or more roadways traveled by the vehicles and store the images in a datastore 414. The images may comprise frames of video image (e.g., from a dashcam or a smartphone attached to a windshield of the vehicle), still images (e.g., from a smartphone attached to a windshield of the vehicle), images captured by a perception sensor integrated within the vehicle (e.g., a vehicle camera, radar, lidar, etc.), or other types of images.

The example server 404 is configured to receive from the plurality of vehicles, construction detection data identifying a potential construction zone location. The construction detection data may be stored in a datastore 416. The construction detection data may include location data, image frame identification data identifying the frames of image data for the location, and construction zone type identification data indicating whether the construction zone data relates to a new construction zone, the continued existence of a previously identified construction zone, or the lack of existence of a previously identified construction zone.

The example server 404 is configured to store a listing of areas to avoid in a datastore 420. The example server 404 is also configured to transmit data from the listing of areas to avoid to an AV 422 for use by the AV 422 in identifying areas to avoid 423. The example server 404 is also configured to transmit data from the listing of areas to avoid to a plurality of construction detection modules 402 in crowd source vehicles. The listing may be transmitted to the AV periodically, after each update to the listing, upon demand by the AV, based on some combination of the foregoing criteria, or based on other criteria. Similarly, the listing may be transmitted to the plurality of construction detection modules 402 periodically, after each update to the listing, upon demand by the plurality of construction detection modules 402, based on some combination of the foregoing criteria, or based on other criteria.

The example system 400 further includes a mapper 418. The example mapper 418 is configured to review the location data and images corresponding to the location data to confirm the existence or non-existence of a construction zone. The example mapper 418 is also configured to cause the location of a construction zone to be added to a listing of areas to avoid when the existence of a construction zone is confirmed. The example mapper 418 is further configured to cause the location of a construction zone to be removed from a listing of areas to avoid when the non-existence of a construction zone is confirmed. The example mapper 418 may be a human mapper. Additionally, or alternatively, the mapper may be a computer implemented mapper.

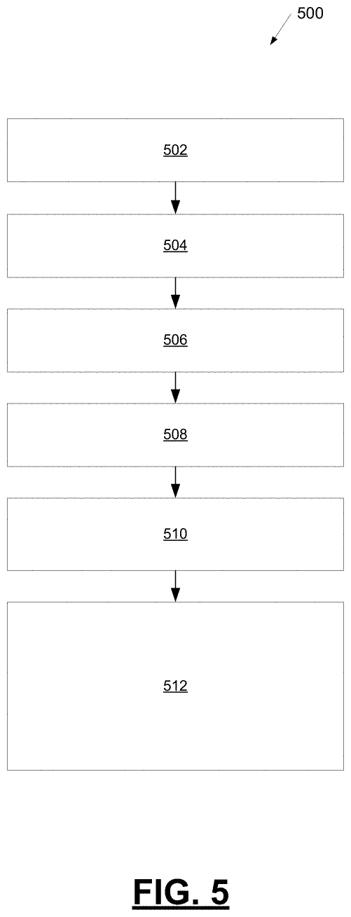

FIG. 5 is a process flow chart depicting an example process 500 in a vehicle for crowd sourced detection of construction zones. The order of operation within the example process 500 is not limited to the sequential execution as illustrated in the figure, but may be performed in one or more varying orders as applicable and in accordance with the present disclosure.

The example process 500 includes automatically capturing, via an onboard optical sensor on a vehicle, a plurality of images of a road along a path traveled by the vehicle (operation 502). The plurality of images may comprise frames of video image (e.g., from a dashcam or a smartphone attached to a windshield of the vehicle), still images (e.g., from a smartphone attached to a windshield of the vehicle), images captured by a perception sensor integrated within the vehicle (e.g., a vehicle camera, radar, lidar, etc.), or other types of images.

The example process 500 includes transmitting at least a portion of the captured images to an off-board datacenter (operation 504). In one example, transmitting at least a portion of the captured images to an off-board datacenter comprises transmitting to the datacenter frames of image data that provide evidence that a new construction zone exists. In another example, transmitting at least a portion of the captured images to an off-board datacenter comprises transmitting to the datacenter frames of image data that provide evidence that a construction zone location on a listing of active construction zones continues to exist. In another example, transmitting at least a portion of the captured images to an off-board datacenter comprises transmitting to the datacenter frames of image data that provide evidence that a construction zone location on a listing of active construction zones no longer exists. In another example, transmitting at least a portion of the captured images to an off-board datacenter comprises transmitting all captured images to the datacenter.

The example process 500 includes identifying, by a processor in the vehicle, images that provide evidence of the existence or non-existence of a construction zone on the road (operation 506). In one example, identifying images comprises identifying frames of image data that provide evidence that a new construction zone exists. In another example, identifying images comprises identifying frames of image data that provide evidence that a construction zone location on a listing of active construction zones no longer exists. In another example, identifying images comprises identifying frames of image data that provide evidence that a construction zone location on a listing of active construction zones continues to exist.

The example process 500 includes transmitting, to the datacenter, location data identifying the location of the construction zone (operation 508). The example process 500 also includes transmitting, to the datacenter, image frame identification data identifying the frames of image data that provide evidence of the existence of the construction zone (operation 510).

In one example, transmitting, to the datacenter, location data and image frame identification data further comprises receiving a copy of the listing of active construction zones; reviewing images corresponding to a location that is not identified in the listing of active construction zones as corresponding to a construction zone; determining that a construction zone exists at the location; and transmitting, to the datacenter, construction zone identification data indicating that a new construction zone exists at the location.

In another example, transmitting, to the datacenter, location data and image frame identification data comprises receiving a copy of the listing of active construction zones; reviewing images corresponding to a first construction zone location identified in the listing of active construction zones; and confirming that a construction zone exists at the construction zone location identified in the listing of active construction zones.

In another example, transmitting, to the datacenter, location data and image frame identification data further comprises receiving a copy of the listing of active construction zones; reviewing images corresponding to a second construction zone location identified in the listing of active construction zones; determining that a construction zone does not exists at the second construction zone location; and transmitting, to the datacenter, construction zone identification data indicating that a construction zone does not exist at the second construction zone location.

In another example, transmitting, to the datacenter, location data and image frame identification data occurs when it is determined that a new construction zone exists at a location that is not identified in the listing of active construction zones or when it is determined that a construction zone does not exist at a construction zone location identified in the listing of active construction zones. In this example, location data and image frame identification data is not transmitted to the datacenter when it is confirmed that a construction zone exists at the construction zone location identified in the listing of active construction zones.

The example process 500 includes reviewing, by a mapper external to the vehicle, the location data and a portion of the transmitted images corresponding to the image frame identification data to confirm the existence of a construction zone and causing, by the mapper, the location of the construction zone to be added to a listing of active construction zones when the existence of the construction zone is confirmed (operation 512). In one embodiment, the mapper comprises a person trained to confirm the existence of a construction zone through reviewing the transmitted images. In another embodiment, the mapper comprises an off-board processing module configured by programming instructions to confirm the existence of a construction zone through reviewing the transmitted images.

In one example, reviewing, by the mapper, the portion of the transmitted images corresponding to the image frame identification data further comprises reviewing images that confirm that a construction zone does not exists at a construction zone location included in the listing of active construction zones and causing, by the mapper, the location of the construction zone to be removed from the listing of active construction zones.

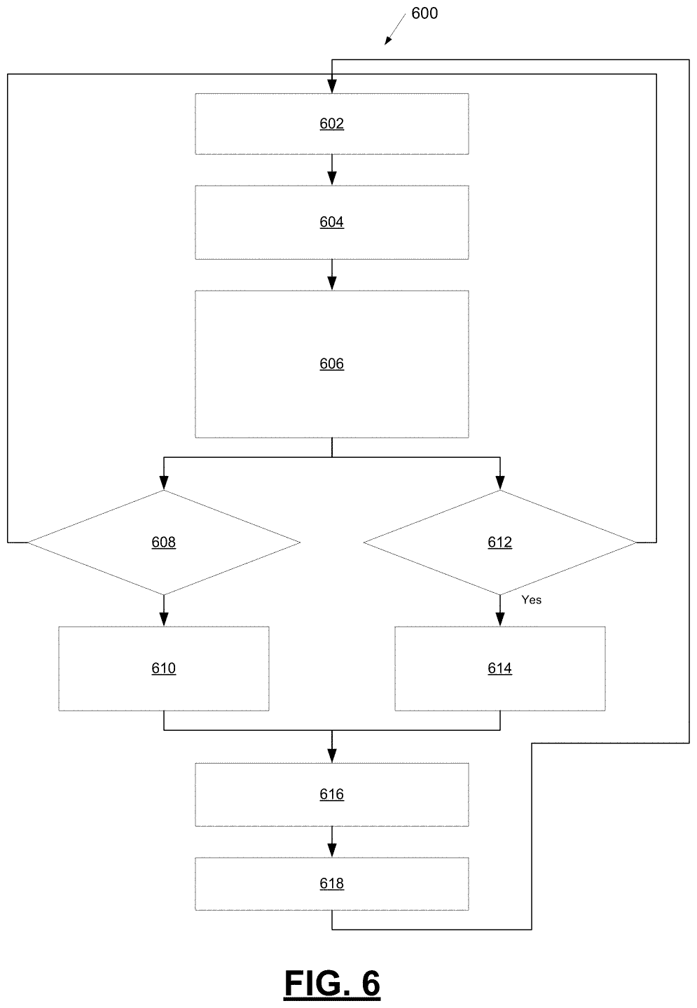

FIG. 6 is a process flow chart depicting an example process 600 in a server for crowd sourced detection of construction zones. The order of operation within the example process 600 is not limited to the sequential execution as illustrated in the figure, but may be performed in one or more varying orders as applicable and in accordance with the present disclosure.

The example process 600 includes receiving, by a processor from a plurality of vehicles, images of one or more roadways traveled by the vehicles (operation 602). The images may comprise frames of video image (e.g., from a dashcam or a smartphone attached to a windshield of the vehicle), still images (e.g., from a smartphone attached to a windshield of the vehicle), images captured by a perception sensor integrated within the vehicle (e.g., a vehicle camera, radar, lidar, etc.), or other types of images.

The example process 600 includes receiving, by the processor from one or more of the plurality of vehicles, first construction zone data identifying a potential construction zone location (operation 604). The construction zone data may include location data, image frame identification data identifying the frames of image data for the location, and construction zone type identification data indicating whether the construction zone data relates to a new construction zone, the continued existence of a previously identified construction zone, or the lack of existence of a previously identified construction zone.

The example process 600 includes reviewing the construction zone data and images corresponding to the construction zone data to determine whether the construction zone data relates to a new construction zone, the continued existence of a previously identified construction zone, or the lack of existence of a previously identified construction zone (operation 606). The reviewing may be performed by a human mapper, a computerized mapper, or some combination of the two. If it is determined that the construction zone data relates to the existence of a previously identified construction zone, then the process continues with receiving new images (operation 602) and construction zone data (operation 604).

If it is determined that the construction zone data relates to a new construction zone, a mapper reviews the construction zone data and images corresponding to the construction zone data to confirm whether a new construction zone has been identified (decision 608). If it is determined that a new construction zone has been identified (yes at decision 608), then the location corresponding to the new construction zone is added to a listing of confirmed construction zones (operation 610). If it is determined that a new construction zone has not been identified (no at decision 608), then the process continues with receiving new images (operation 602) and construction zone data (operation 604).

If it is determined that the construction zone data relates to the non-existence of a previously identified construction zone, a mapper reviews the construction zone data and images corresponding to the construction zone data to confirm whether the previously identified construction zone no longer exists (decision 612). If it is determined that the previously identified construction zone no longer exists (yes at decision 612), then the location corresponding to the previously identified construction zone is removed from the listing of confirmed construction zones (operation 614). If it is determined that the previously identified construction zone continues to exist (no at decision 612), then the process continues with receiving new images (operation 602) and construction zone data (operation 604).

The example process 600 includes transmitting the listing of active construction zones to an autonomous vehicle (AV) for use by the AV in identifying areas to avoid (operation 616). The listing may be transmitted to the AV periodically, after each update to the listing, upon demand by the AV, based on some combination of the foregoing criteria, or based on other criteria.

The example process 600 includes transmitting the listing of active construction zones to the plurality of vehicles (operation 618). The listing may be transmitted to the plurality of vehicles periodically, after each update to the listing, upon demand by the plurality of vehicles, based on some combination of the foregoing criteria, or based on other criteria.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A processor-implemented method for construction zone detection, the method comprising:
automatically capturing, via an onboard optical sensor on a vehicle, a plurality of images of a road along a path traveled by the vehicle;
transmitting at least a portion of the captured images to an off-board datacenter;
identifying, by a processor in the vehicle, images that provide evidence of the existence of a construction zone on the road at a first construction zone location;
transmitting, to the datacenter, location data identifying the first construction zone location; and
transmitting, to the datacenter, image frame identification data identifying frames of image data that provide evidence of the existence of the construction zone at the first construction zone location;
wherein the location data and images corresponding to the image frame identification data are reviewed off-board the vehicle to confirm the existence of the construction zone at the first construction zone location and the first construction zone location is added to a listing of active construction zones when the existence of the construction zone at the first construction zone location is confirmed.

2. The method of claim 1, wherein the location data and images corresponding to the image frame identification data are reviewed by an off-board processing module configured by programming instructions to confirm the existence of a construction zone through reviewing the transmitted images.

3. The method of claim 1, wherein the location data and images corresponding to the image frame identification data are reviewed by a person trained to confirm the existence of a construction zone through reviewing the transmitted images.

4. The method of claim 1, further comprising receiving a copy of the listing of active construction zones.

5. The method of claim 4, wherein transmitting at least a portion of the captured images to an off-board datacenter comprises transmitting to the datacenter the frames of image data that provide evidence that a construction zone exists at the first construction zone location, wherein the first construction zone location is not included in the listing of active construction zones.

6. The method of claim 4, further comprising:
reviewing images corresponding to a second construction zone location identified in the listing of active construction zones; and
confirming that a construction zone exists at the second construction zone location.

7. The method of claim 6, wherein transmitting at least a portion of the captured images to an off-board datacenter comprises transmitting to the datacenter frames of image data that provide evidence that a construction zone exists at the second construction zone location.

8. The method of claim 4, further comprising:
reviewing images corresponding to a third construction zone location identified in the listing of active construction zones;
determining that a construction zone does not exist at the third construction zone location; and
transmitting, to the datacenter, construction zone identification data indicating that a construction zone does not exist at the third construction zone location and identifying the frames of image data that provide evidence that a construction zone does not exist at the third construction zone location.

9. The method of claim 8, wherein transmitting at least a portion of the captured images to an off-board datacenter comprises transmitting to the datacenter the frames of image data that provide evidence that the third construction zone does not exist.

10. The method of claim 1, wherein the captured images comprise a dashcam video captured from a dedicated dashcam device or images captured from a smartphone in the vehicle.

11. The method of claim 1, wherein the captured images comprise images captured by a perception sensor integrated within the vehicle.

12. A construction zone detection module in a vehicle, the construction zone detection module comprising one or more processors configured by programming instructions in non-transient computer readable media, the construction zone detection module configured to:
capture, via an onboard optical sensor on a vehicle, a plurality of images of a road along a path traveled by the vehicle;
transmit at least a portion of the captured images to an off-board datacenter;
identify images that provide evidence of the existence of a construction zone on the road at a first construction zone location;
transmit, to the datacenter, location data identifying the first construction zone location; and
transmit, to the datacenter, image frame identification data identifying frames of image data that provide evidence of the existence of the construction zone at the first construction zone location;
wherein the location data and images corresponding to the image frame identification data are reviewed off-board the vehicle to confirm the existence of the construction zone at the first construction zone location and the first construction zone location is added to a listing of active construction zones when the existence of the construction zone at the first construction zone location is confirmed.

13. The module of claim 12, further configured to:
save a copy of the listing of active construction zones received from the datacenter;
review images corresponding to a second construction zone location identified in the listing of active construction zones; and
confirm that a construction zone exists at the second construction zone location identified in the listing of active construction zones.

14. The module of claim 13, configured to transmit to the datacenter the frames of image data that provide evidence that the construction zone exists at the second construction zone location.

15. The module of claim 12, further configured to:
save a copy of the listing of active construction zones received from the datacenter;
review images corresponding to a third construction zone location identified in the listing of active construction zones;
determine that a construction zone does not exists at the third construction zone location; and
transmit, to the datacenter, third construction zone identification data indicating that a construction zone does not exist at the third construction zone location.

16. The module of claim 15, configured to transmit to the datacenter frames of image data that provide evidence that a construction zone does not exist at the third construction zone location, and wherein the third construction zone identification data identifies the frames of image data that provide evidence that a construction zone does not exist at the third construction zone location.

17. A processor-implemented method for construction zone detection, comprising:
receiving, by a processor from a plurality of vehicles, images of a road traveled by the vehicles;
receiving, by the processor from one or more of the plurality of vehicles, first construction zone data identifying a potential construction zone location;
reviewing the first construction zone data and images corresponding to the first construction zone data to confirm the existence of a construction zone at the potential construction zone location;
adding the potential construction zone location to a listing of active construction zones when the existence of a construction zone at the potential construction zone location is confirmed; and
transmitting the listing of active construction zones to an autonomous vehicle (AV) for use by the AV in identifying areas to avoid.

18. The method of claim 17, further comprising:
transmitting the listing of active construction zones to the plurality of vehicles;
receiving, from one or more of the plurality of vehicles, second construction zone data indicating that a former construction zone location included in the listing of active construction zones is no longer an active construction zone;
reviewing the second construction zone data and images corresponding to the second construction zone data to confirm that the former construction zone location is no longer an active construction zone; and
removing the former construction zone location from the listing of active construction zones when it is confirmed that the former construction zone location is no longer an active construction zone.

19. The method of claim 18, wherein reviewing the first construction zone data and images and reviewing the second construction zone data and images are performed by a human mapper trained to review and confirm construction zone data and images.

20. The method of claim 18, wherein reviewing the first construction zone data and images and reviewing the second construction zone data and images are performed by a processing module configured by programming instructions to review and confirm construction zone data and images.
